(19) United States
(12) Patent Application Publication
(10) Pub. No.: US 2020/0170226 A1
(43) Pub. Date: Jun. 4, 2020

(54) Method and System for Underwater Hyperspectral Imaging of Fish

(71) Applicant: Ecotone AS, Trondheim (NO)

(72) Inventor: Lars Martin S. Aas, Trondheim (NO)

(21) Appl. No.: 16/615,861

(22) PCT Filed: May 24, 2018
(86) PCT No.: PCT/NO2018/050136

§ 371 Date: Nov. 22, 2019

(30) Foreign Application Priority Data
May 29, 2017 (NO) 20170876

(51) Int. Cl. A01K 61/00; H04N 5/225; H04N 5/265; G06K 9/46; G06K 9/62; G06T 7/00; G06T 7/40

(52) U.S. Cl. CPC A01K 61/00; H04N 5/2256; H04N 5/265; G06K 9/4661; G06K 9/6271; G06K 2009/4657; G06T 7/40; G06T 2207/20224; G06T 2207/10036; G06T 2207/20221; G06T 7/0014

(57) ABSTRACT

Method and system for underwater hyperspectral imaging of fish comprising hyperspectral imaging of a fish freely moving in an observation area and identifying and classifying physiological properties of fish or identifying and classifying on identified fish.

The disclosed embodiments are related to a method for underwater hyperspectral imaging of fish and a system for underwater hyperspectral imaging of fish. More particularly, the present disclosure is related to a method and system for underwater hyperspectral imaging of fish for detecting and classifying physiological properties of fish or detecting and classifying specimen on fish.

### BACKGROUND

The aquaculture industry in general, and fish-farming of fishes in the Salmonidae fish family is a growing industry on an international scale.

Problems easily occur when fish are kept at high densities. Contaminations of diseases and parasites within the fish farm are common. To secure the fish health and limit contamination to wild fish authorities put forward regulations to control the health situation for the farmed and the wild stocks of fish. One example of such a regulation is the maximum limit for sexually mature female sea lice, where frequent estimation of the level of lice has to be reported to the authorities. These estimations are today based on counting the number of lice on a fraction of fish, typically 10 to 20 of 100 000 to 200 000 fish. This means that neither the fish farmers nor the authorities do have full control of the situation of contamination.

When imaging a scene using a traditional digital imaging sensor or by eye, the intensity of light from each point or pixel of an imaged scene can be determined for each of three wide wavelength bands (centered around red, green and blue for a digital camera, and yellowish-green, green and bluish-violet for the human eye). Information about the full spectral emissions (i.e. a continuous graph of intensity over wavelength) of the scene can, at best, be represented by a convolution in a three-dimension color space, necessitating a loss of information.

Both multispectral sensors have been used in research into aquatic (freshwater, brackish water and salt water) environments for about 30 years. Multispectral sensors are divided into more than three discrete color bands and so give more detailed spectral information compared to regular color digital cameras. They have typically been carried in satellites, airplanes, buoys and boats to analyze upwelling radiance remotely, and in underwater vehicles to measure both upwelling and downwelling radiance in situ. In both cases the light measured by the sensor comes from natural illumination that is incident on the water. Hyperspectral sensors are also known. These have a much better wavelength resolution than multispectral sensors and can operate over a broad range of photon wavelengths from the ultraviolet to the infrared. It is also known to use hyperspectral sensors for imaging purposes in passive remote sensing. A hyperspectral imager (also known as an imaging spectrometer, imaging spectroscope, imaging spectroradiometer, superspectral or ultraspectral imager), can determine the light intensity from each point or pixel of a scene for each of a large number (typically hundreds) of wavelength bands. This results in far more spectral information about the scene being preserved than is the case when just three bands are available, as for conventional imaging. Because hyperspectral imagers give such detailed spectral information for each pixel in the image, independently of each other, it is possible to identify regions containing types of matter, such as chemical substances and organisms, by using their known unique spectra. Applications for hyperspectral imagers include mineral exploration, agriculture, astronomy and environmental monitoring. They are typically used in airplanes (so-called “remote sensing”). An overview of the use of hyperspectral sensors in oceanography is given is “The New Age of Hyperspectral Oceanography” by Chang et al, in Oceanography, June 2004, pp. 23-29. WO 2005/054799 discloses the use of a hyperspectral imager from airborne platforms to observe coastal marine environments remotely. The use of an airborne hyperspectral imager for mapping kelp forest distribution close to the shore is described in “Kelp forest mapping by use of airborne hyperspectral imager” by Volent et al. in Journal of Applied Remote Sensing, Vol. 1, 011503 (2007).

EP2286194 B1 discloses an apparatus for placement on or in a body of water for hyperspectral imaging of material in the water comprises an artificial light source and a hyperspectral imager. These are arranged so that in use light exits the apparatus beneath the surface of the water and is reflected by said material before re-entering the apparatus beneath the surface of the water and entering the hyperspectral imager. The hyperspectral imager is adapted to produce hyperspectral image data having at least two spatial dimensions.

A drawback of this latter solution, and other prior art, is that they are not adapted for being arranged to fixed installations, imaging moving objects. Further, they are not arranged for compensating water optical effects. Accordingly, they are not suitable for hyperspectral imaging of freely moving fish for detecting and classifying physiological properties of fish or detecting and classifying specimen on fish.

Accordingly, there is a need for a method and system for underwater hyperspectral imaging of fish capable of quantifying the extent of parasites and diseases caused by infections (bacteria or viruses), parasites, diet, environmental conditions, etc.

It is further a need for a method and system for underwater hyperspectral imaging of fish capable of detecting and classifying different life stage of parasites.

There is also a need for a method and system for underwater hyperspectral imaging of fish capable of detecting fish and classifying the different life stages of the fish.

There is further a need for a method and system for underwater hyperspectral imaging of fish capable of detecting and classifying between different stages of parr-smolt transition for ensuring best timing for moving juveniles from freshwater to the sea.

### SUMMARY

The disclosed embodiments provide a method and system for underwater hyperspectral imaging of fish partly or entirely solving the mentioned drawbacks of prior art.

Also provided is a method and system for underwater hyperspectral imaging of fish for detecting and classifying physiological properties of fish.

Also provided is a method and system for underwater hyperspectral imaging of fish for detecting and classifying specimen on fish.

The disclosed method and system for underwater hyperspectral imaging of fish is capable of quantifying the extent of parasites and diseases.

The disclosed method and system for underwater hyperspectral imaging of fish is capable of identifying and classifying different life stages of the fish.

The disclosed method and system for underwater hyperspectral imaging of fish is capable of identifying and classifying between different stages of parr-smolt transition of fish.

The disclosed method and system for underwater hyperspectral imaging of fish can be arranged to a fixed installation, imaging freely moving fish.

The disclosed method and system for underwater hyperspectral imaging of fish can also compensate for water optical effects.

The disclosed method and system for underwater hyperspectral imaging of fish allows the collection of information obtained from a large number of fish and use of such information to make decisions on actions to secure animal welfare and reduce the risk of contamination to other fish farms and to the wild.

The disclosed method and system for underwater hyperspectral imaging of fish is capable of detecting and classifying physiological properties of fish or detecting and classifying specimen on the surface of fish by means of hyperspectral imaging.

Specimens may be Lepeophterius salmonis (Kr0yer, 1837), Caligus elongates (Nordmann, 1832), wounds caused by handling, wounds caused by parasites, or wounds caused by diseases.

Physiological properties can be life stage of fish or parr-smolt transition.

A method for underwater hyperspectral imaging of fish according to the present comprises hyperspectral imaging of an observation area of interest. Hyperspectral imaging of fish in the observation area is according to the disclosed embodiments performed by using at least one illumination source and at least one hyperspectral imager arranged in a fixed position in relation to the observation area, wherein the hyperspectral imager provides a raw 2D projection of the convolution of the at least one illumination source and at least one hyperspectral imager and spectral properties of a section (frame) of a fish moving in relation to the observation area.

According to the disclosed embodiments, the movement of the fish as it swims through the observation area is used to build a two-dimensional image of the fish. As the fish swims through the observation area the at least one hyperspectral imager captures sequential frames as the fish moves in relation to the observation area. The sequential frames can be processed and composed to generate a complete image (hypercube) of a fish. If desired, this complete image (hypercube) can be used to generate two-dimensional flat greyscale images indicating light intensity at each pixel for a given single optical wavelength range. Accordingly, by utilizing the movement of the freely moving fish, a complete image of a fish can be captured.

The method for underwater hyperspectral imaging of fish further comprises identifying fish in the complete image by evaluating connected pixels in the complete image having a certain intensity threshold. Fish have a shiny surface which reflects light above a certain intensity. By considering only connected pixels above a certain intensity threshold one can relate these connected pixels to coming from a fish in the observation area, and accordingly a fish in the complete image. The method further comprises extracting area around each fish in the complete image, i.e. extracting area having lower intensity than the intensity threshold. By choosing or tailoring the emission spectrum of the light source to the reflectance spectrum of the fish one ensures that the fish is illuminated by all the desired wavelengths corresponding to peaks in its reflection spectrum.

The disclosed method for underwater hyperspectral imaging of fish further preferably comprises spectral correction of optical properties of the water. This is achieved by using measurements of the optical properties of water to model the statistical distribution of the optical properties of the water to each pixel in the complete image of a fish. Further, this contribution is subtracted from the optical properties in the complete image of the fish to provide a spectral image of the identified fish.

For measurement of the optical properties of the water, the method according to one disclosed embodiment comprises using a separate illumination source, such as a spectral lamp, illuminating a desired light, and a detector arranged at a known distance from the separate illumination source to determine attenuation coefficient of water which can be used as spectral correction parameters for subtraction.

The method can further comprise accumulating spectral images of fishes at various distances, and by means of the determined attenuation coefficient, project the determined attenuation coefficient spectrum on all spectra and estimate the statistical contribution of the attenuation coefficient spectra to all spectra on all fishes in the image. The method can further comprise checking if the contribution is continuous, and if this is the case, subtract the contribution of the attenuation coefficient spectra on every single pixel of the complete image, resulting in a standardized spectral image.

The disclosed method for underwater hyperspectral imaging of fish further comprises identifying and classifying physiological properties of fish or identifying and classifying specimen on fish. This is achieved by comparing the spectral image or standardized spectral image of the fish with spectral signatures from one or more databases to classify all pixels in the spectral image or standardized spectral image.

For identifying and classifying specimen on fish the method further comprises extracting each specimen as an object. This can be performed by grouping connected pixels of same identified class.

According to a second embodiment of the method for underwater hyperspectral imaging of fish the method further comprises determining development stage of the detected specimen object. This is achieved by, based on the grouping of connected pixels of same identified class, calculating texture properties, hereunder size and shape, and comparing the texture properties of the specimen object with spectral signatures of specimen of different development stage from a database, Based on this the method further preferably comprises estimation of the probability if the specimen being of various types.

According to a further embodiment of the method for underwater hyperspectral imaging of fish, the method further comprises identifying and classifying wounds (large, small on fins or bleeding), changes in skin color, changes in gill color, spots, darker color, loss of scales, changes in the eye or growth of wart-like excrescence by comparing the spectral image or standardized spectral image of the fish with spectral signatures for wounds, skin color, gill color, scales, eye, wart-like excrescences from a database.

According to yet a further embodiment of the method for underwater hyperspectral imaging of fish, the method further comprises identifying and classifying life stage of the detected fish by comparing the spectral image or standardized image of the fish with spectral signatures of fish at different life stages, such as Egg stage, Yolk stage, Larval/alevin stage or Metamorphosis stage Juvenile stage from a database.

According to a further embodiment of the method for underwater hyperspectral imaging of fish, the method further comprises identifying and classifying between different stages of parr-smolt transition of fish by comparing the spectral image or standardized image of the fish with spectral signatures of different stages of parr-smolt transition from a database.

The method can further comprise monitoring each of the above mentioned embodiments.

The collection of information obtained from a large number of fish can in turn be used to make decisions on actions to secure animal welfare and reduce the risk of contamination to other fish farms and to the wild.

A system for underwater hyperspectral imaging of fish comprises at least one illumination source and at least one hyperspectral imager for hyperspectral imaging of a fish moving freely in an observation area providing a raw 2D projection of the convolution of the at least one illumination source and at least one hyperspectral imager and spectral properties of a section of a fish moving in the observation area.

The system further comprises a control unit provided with means and/or software for utilizing movement of the fish in relation to the observation area to build a two dimensional image of the fish from sequential sections of the fish captured by the at least one hyperspectral imager as it moves in relation to the observation area and processing and composing the sequential sections to generate a complete image of the fish.

The control unit for the system is further provided with means and/or software for identifying the fish in the complete image by evaluating connected pixels in the complete image having a certain intensity threshold, and extracting area around the fish in the complete image having intensity lower than the intensity threshold.

In a further embodiment of the system the system further comprises a device for measuring optical properties of water formed by at least one separate illumination source and at least one detector, arranged at a known distance from each other.

According to a further embodiment of the system the control unit is provided with means and/or software for, based on the measured optical properties of the water, model the statistical distribution of the optical properties of the water to each pixel in the complete image of the observation area, providing an attenuation coefficient spectrum, and subtracting this attenuation coefficient spectrum from the optical properties in the complete image of the identified fish to provide a spectral image of the identified fish.

In yet a further embodiment of the system the control unit further is provided with means and/or software for accumulating spectral images of fishes at various distances by utilizing the attenuation coefficient spectrum by projecting the attenuation coefficient spectrum on all spectra and estimate statistical contribution of the attenuation coefficient spectra on all fishes in the complete image checking if the contribution is continuous and if that is the case, the contribution of the attenuation coefficient spectrum can be subtracted on every single pixel to provide a standardized spectral image of fishes in the complete image.

According to a further embodiment of the control unit for the system is further provided with means and/or software for identifying specimen on the complete image of the identified fish by classifying all pixels in an image by comparison with spectral signatures of specimen stored in a database and extracting each specimen as an object.

In a further embodiment of the system the control unit is further provided with means and/or software for grouping pixels of same class and calculate texture properties thereof, hereunder size and shape, and extracting each specimen as an object.

According to a further embodiment of the system the system comprises at least one database holding spectral signatures of specimen at different development stage, and that the control unit is arranged for comparing the texture properties of the specimen with the spectral signatures of the specimen at different development stage in the database for determining development stage of specimen object.

An embodiment of the system comprises at least one database holding spectral signatures for wounds (large, small on fins or bleeding), changes in skin color, changes in gill color, spots, darker color, loss of scales, changes in the eye or growth of wart-like excrescence, and the control unit is provided with means and/or software for comparing the spectral image or standardized spectral image of the fish with spectral signatures for wounds, skin color, gill color, scales, eye, wart-like excrescences in the database.

An embodiment of the system comprises at least one database holding spectral signatures of fish at different life stages, such as Egg stage, Yolk stage, Larval/alevin stage or Metamorphosis stage Juvenile stage, and the control unit is provided with means and/or software for comparing the spectral image or standardized spectral image of the fish with spectral signatures for the different life stages in the database.

An embodiment of the system comprises at least one database holding spectral signatures for different stages of parr-smolt transition of fish, and the control unit is provided with means and/or software for comparing the spectral image or standardized spectral image of the fish with spectral signatures the different stages of parr-smolt transition in the database.

Accordingly, as disclosed herein, there is provided a method and system for underwater hyperspectral imaging of fish capable of quantifying the extent of parasites and diseases caused by infections (bacteria or viruses), parasites, diet, environmental conditions, etc. By the disclosed method and system, symptoms like visible parasites (such as sea louse), wounds (large, small on fins or bleeding), changes in skin color, changes in gill color, spots, darker color, loss of scales, changes in the eye, growth of wart-like excrescence, physiological deformation or behavior can be detected and registered. In addition to this different life stages of the mentioned parasites can be detected, which will provide valuable information.

In fish farms, the early life stages of the fish stock are monitored, as the different life stages require different physical environment and feeding regimes. For instance, the fish need appropriate size of food particles of live feed based on their life stage. The stages are characterized by morphological traits. By means of the disclosed method and system for underwater hyperspectral imaging of fish the fish can be detected and classified at the different stages, either in their ordinary tanks/cages or in specially designed set-up. By means of the disclosed method and system, stages of fish can be separated between one or more of: Egg stage, Yolk sac stage, Larval/alevin stage, Metamorphosis stage Juvenile stage.

Anadrome fishes spend the first part of their lives in fresh water and the adult life in sea water. The juvenile salmonid fishes undergo a set of physiological changes, enabling them to adapt from a freshwater life to a sea water life. This transformation is known as parr-smolt transformation (smoltification/metamorphose). In the aquaculture industry, this transition is monitored to ensure best timing for moving juveniles from freshwater to the sea (In nature, they move gradually: freshwater-brackish water-sea). By means of the method and system for underwater hyperspectral imaging of fish it is possible to identify and classify between different stages of the parr-smolt transformation based on that the parr has a distinct pattern of vertical spots on the side, used for camouflage in nature. As they undergo metamorphose, they gradually lose the spots and become smolt where the smolt gets silvery scales.

Further preferable features and advantageous details of the disclosed embodiments will appear from the following example description, claims and attached drawings.

### BRIEF DESCRIPTION OF THE DRAWINGS

The present invention will below be described in further detail with references to the attached drawings, where:

FIG. 1 is a principle drawing of an application area of the disclosed embodiments,

FIG. 2 is a principle drawing of is a schematic, perspective drawing of the principle components of a hyperspectral imager as used in the disclosed embodiments,

FIG. 3 is a block diagram of an embodiment of the disclosed system, and

FIG. 4 is a principle drawing of a device for measuring optical properties of water.

### DETAILED DESCRIPTION

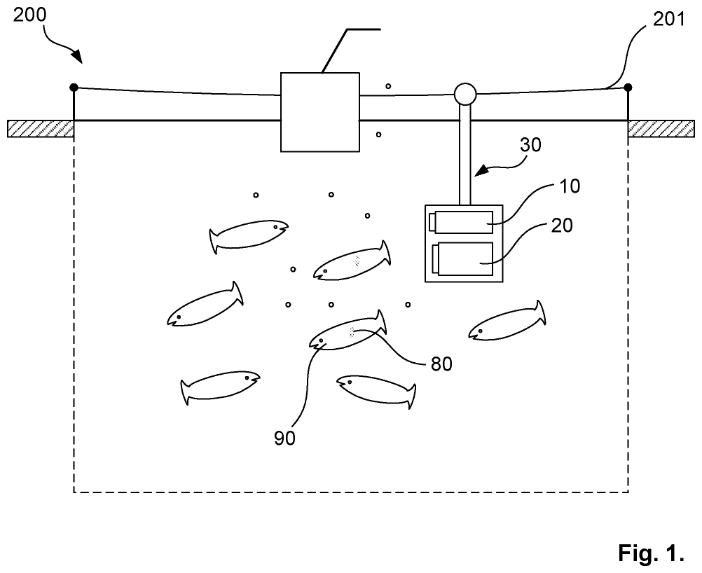

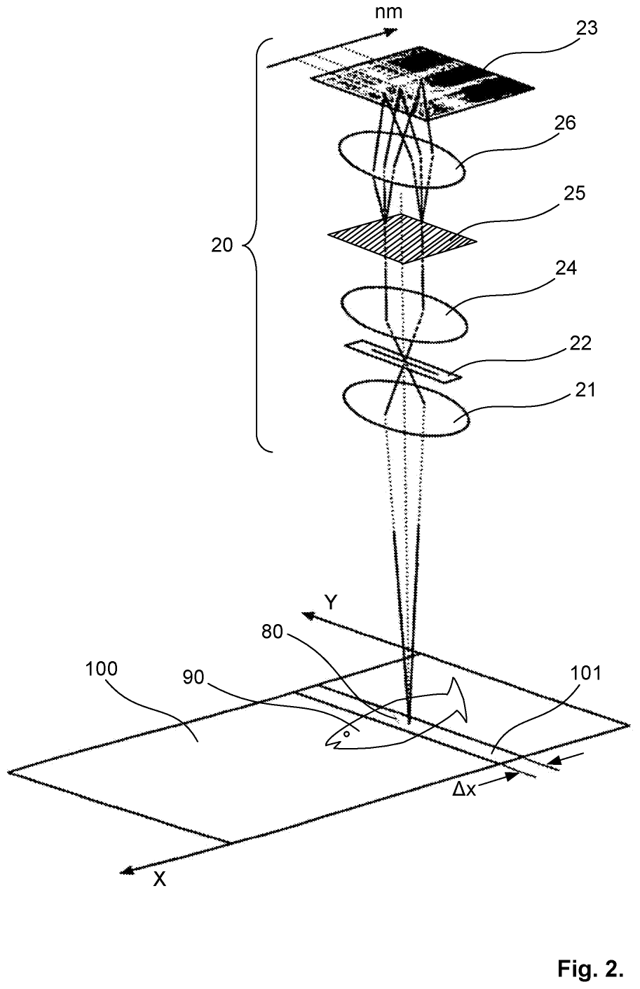

Reference is first made to FIG. 1 showing a principle drawing of a system for hyperspectral imaging of fish 90 arranged, fixed in a fish farm 200, The disclosed system comprises at least one illumination source 10 and at least one hyperspectral imager 20 arranged to a mounting assembly 30 for arrangement, fixed or movable, to a support structure 201 of the fish farm 200. The at least one illumination source 10 and at least one hyperspectral imager 20 can be arranged side by side, or over or under each other such that they exhibit an angle in relation to each other in relation to an observation area 100 (FIG. 2).

The system can be provided with several illumination sources 10 which can be used individually or in combination to provide a customized illumination. This can be used to minimize the effects of absorption and scattering in the water between the illumination source, imaged fish 90 and the hyperspectral imager 20, and can also ensure that the correct wavelengths in the imaged fish 90 are excited.

The illumination source 10 can e.g. be formed by a plurality of light emitting diodes (LED) which can be selectively illuminated. E.g. some of the LEDs can preferably be white, emitting light in the 350-800 nm range, others can preferably be blue, emitting light in 370-500 nm range or green, emitting light in 500-600 nm range or red, emitting light in 600-700 nm range.

The hyperspectral imager 20 can e.g. be a hyperspectral microscopic imager as described in EP2286194 B1.

By using several, at least two, hyperspectral imagers 20, one can achieve stereoscopic vision and achieve reliable estimation of the distance to the fish 90 in addition to estimation of the size/volume of the fish 90. When using several hyperspectral imagers 20, the hyperspectral imagers 20 will be arranged to observe the fish 90 from different angles. The use of at least two hyperspectral imagers 20 observing a fish 90 from at least two different angles will also result in higher detection rate for specimens 80 on the fish 90 due to the hyperspectral imagers 20 are observing the fish 90 from at least two angles.

By using several, at least two, illumination sources 10 one can achieve complete shadowing by objects moving in front of one illumination source 10 or sitting on the illumination source 10.

Reference is now made to FIG. 2 which is a schematic, perspective drawing of the principle components of a hyperspectral imager 20 as used in embodiments. The hyperspectral imager 20 is arranged to form an image having two spatial dimensions, as will be described with reference to FIG. 2.

FIG. 2 shows how light passes from an observation area 100 of interest through the optics of a push-broom hyperspectral imager during the capture of a single frame. Only a thin section 101 of the observation area 100 is imaged during each time frame, extending in the direction of the Y axis and having width ΔX. Light from the observation area 100 first passes through an objective lens 21 which focuses it through a spatial slit 22. The spatial slit 22 excludes light other than that emanating from the section 101. Its width is set to relate desired width ΔX to the width of a single row of pixels of a CCD image sensor 23. A collimating lens 24 then directs light through a dispersive grating 25 arranged to create a dispersed spectrum. The spectral dispersion occurs over the X axis, orthogonal to the spatial dimension Y of the section 101. A camera lens 26 then focuses the spectrally dispersed light onto the CCD image sensor 23.

The disclosed embodiments utilize the movement of the freely moving fish 90 to build up a two-dimensional image of fish 90 in the observation area 100. By that the fish 90 moves, there is no need for the objective lens 21 and other optics to be moved laterally relative to the observation area 100 in the direction of the X axis. The sequential sections 101 (frames) of a fish 90 moving/swimming in relation to the observation area 100 can be processed and composed to generate a complete image or a hypercube. If desired, this hypercube can be used to generate two-dimensional flat greyscale images indicating light intensity at each pixel for a given single optical wavelength range. The wavelength resolution of the system is determined by the number of pixels on the CCD sensor 23 in the direction of the X axis.

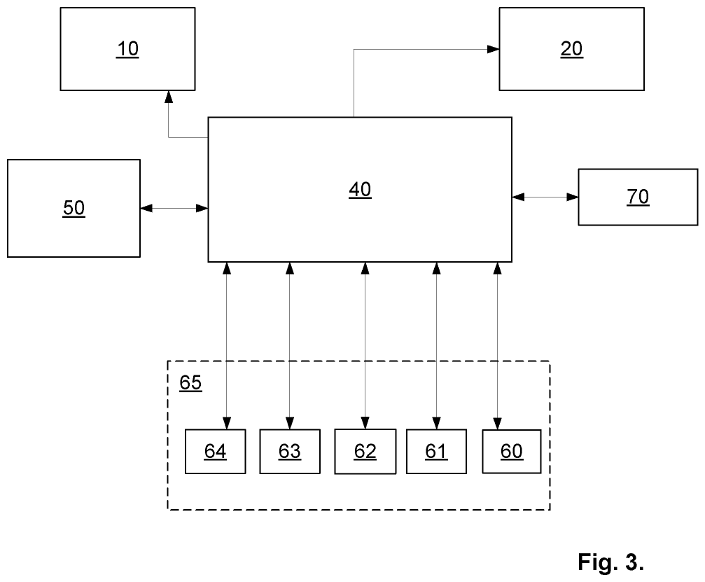

Reference is no made to FIG. 3 showing a block diagram of an embodiment of the disclosed system. The system is further provided with a control unit 40 in the form of a CPU or similar, provided with internal and/or external memory. The control unit 40 is provided with means and/or software for controlling the at least one illumination source 10 and the at least one hyperspectral imager 20.

By means of the at least one illumination source 10 and at least one hyperspectral imager 20 a raw 2D projection of the convolution of the at least one illumination source 10 and the at least one hyperspectral imager 20 and spectral properties of a section 101 of a fish 90 in the observation area 100. As the fish 90 swims/moves, e.g. in X-direction in FIG. 2, one can achieve a number of section images which can be processed and composed to form a complete image of a fish 90 moving in relation to the observation area 100.

The control unit 40 can further be provided with means and/or software for evaluating connected pixels above a certain intensity threshold, as described above, accordingly identifying the fish 90. Based on this the control unit 40 can further be provided with means and/or software for extracting area around each fish based on the evaluation of connected pixels, where pixels with a certain intensity threshold will represent a fish 90 in the observation area 100.

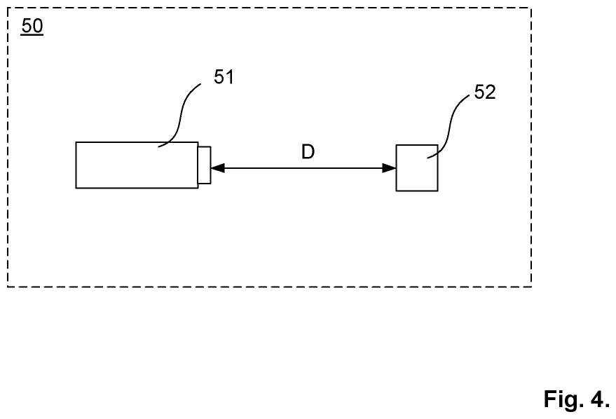

Reference is now made to FIG. 4. A further embodiment of the system further comprises a device 50 for measuring optical properties of water. The device 50 for measuring optical properties of water is e.g. formed by at least one separate illumination source 51 and at least one detector 52, arranged at a known distance D from each other. Further, both the separate illumination source 51 and detector 52 can be controllable or fixed. By means of the device 50 measuring optical properties of water, measurement can be made to model the statistical distribution of the optical properties of the water to each pixel in the complete image of the identified fish 90, providing an attenuation coefficient spectrum, Further, this contribution can be subtracted from the optical properties in the complete image of the identified fish 90 to provide a spectral image of the identified fish 90.

Further, the spectrum of light emanating from the illumination source 10 can be tuned by selecting which LEDs to activate, depending on the optical properties of the water (which vary with distance to the target object due to the spectral attenuation coefficient of water, and which can vary due to optically-active components such as phytoplankton, coloured dissolved organic matter and total suspended matter).

The control unit 40 can further be provided with means and/or software for accumulating spectral images of fishes 90 at various distances by utilizing the above attenuation coefficient spectrum. By projecting the attenuation coefficient spectrum on all spectra and estimate statistical contribution of the attenuation coefficient spectra on all fishes 90 in the complete image one can check if the contribution is continuous and if that is the case, the contribution of the attenuation coefficient spectrum can be subtracted on every single pixel to provide a standardized spectral image of fishes 90 in the complete image.

Reference is now again made to FIGS. 1 and 2, showing specimen 80 on fish 90, and FIG. 3. The disclosed system comprises at least one database 60 stored in the internal or external memory holding spectral signatures of specimen 80. The control unit 40 is further provided with means and/or software for classifying all pixels in a standardized image or complete image according to the signatures stored in the database 60 and extract each specimen 80 as an object. In a typically application, which is a fish farm 200, this will be lice. Accordingly, the disclosed system and method allow for identification of each lice on a fish 90.

According to a further embodiment of the system the control unit 40 can further be provided with means and/or software for grouping pixels of same class and calculate texture properties thereof, such as size and shape. In this embodiment the system comprises at least one database 61 stored in the internal or external memory holding spectral signatures of specimen 80 of different development stage, such as lice at different development stage.

Based on the above described extracted specimen object, the specimen object texture can be compared with the spectral signatures of specimen at different development stage stored in the database 61, whereupon the control unit 40 can estimate the probability of the specimen object being of various types. If the certainty is high the development stage of the specimen object can be specified and if the certainty is low the development stage the development stage cannot be determined.

A further embodiment of the system comprises at least one database 62 stored in the internal or external memory holding spectral signatures for wounds (large, small on fins or bleeding), changes in skin color, changes in gill color, spots, darker color, loss of scales, changes in the eye or growth of wart-like excrescence, and the control unit 40 is provided with means and/or software for comparing the spectral image or standardized spectral image of the fish with spectral signatures for wounds, skin color, gill color, scales, eye, wart-like excrescences in the database 62 for determining wounds (large, small on fins or bleeding), changes in skin color, changes in gill color, spots, darker color, loss of scales, changes in the eye or growth of wart-like excrescence.

Yet a further embodiment of the system comprises at least one database 63 stored in the internal or external memory holding spectral signatures of fish 90 at different life stages, such as Egg stage, Yolk stage, Larval/alevin stage or Metamorphosis stage Juvenile stage, and the control unit 40 is provided with means and/or software for comparing the spectral image or standardized spectral image of the fish 90 with spectral signatures for the different life stages in the database 63 for determining life stage of fish 90.

A further embodiment of the system comprises at least one database 64 stored in the internal or external memory holding spectral signatures for different stages of parr-smolt transition of fish 90, and the control unit 40 is provided with means and/or software for comparing the spectral image or standardized spectral image of the fish 90 with spectral signatures the different stages of parr-smolt transition in the database 64 for determining stages of parr smolt transition of fish 90.

One or more of the above mentioned databases 60-64 can be combined in one or more common databases 65.

All information is then stored in the internal or external memory of the control unit 40 and can further be reported to a user by means of that the system is provided with a wired or wireless communication device 70.

In the shown application area in FIG. 1, the system is preferably arranged in a feeding area of the fish farm 200 such that as many fishes 90 as possible will be examined by the system. By e.g. suspending the system to a wire 201 extending across the fish farm 200, the system can be made movable across the fish farm 200 if required to position the system for optimizing of the position to process as many fish 90 as possible.

Further, the mounting assembly 30 can further be arranged to be movable in vertical direction of the fish farm 200 to provide positioning possibilities in vertical direction of the fish farm 200.

Accordingly, the disclosed embodiments provide a real-time/in situ identification and classification of physiological properties of fish 90 or specimen 80 on fish 90 by hyperspectral imaging.

1-21. (canceled)

22. A method for underwater hyperspectral imaging of fish (90) comprising hyperspectral imaging of fish (90) freely moving in an observation area (100) utilizing at least one illumination source (10) and at least one hyperspectral imager (20) to provide a raw 2D projection of the convolution of the at least one illumination source (10) and at least one hyperspectral imager (20) and spectral properties of a section (101) of a fish (90) moving in relation to the observation area (100), comprising the steps of:
capturing sequential sections (101) of the fish (90) as it moves in relation to the observation area (100);
processing and composing the sequential sections (101) to generate a complete two-dimensional image of the fish (90);
evaluating connected pixels in the complete two-dimensional image having a predetermined intensity threshold;
extracting area around the fish (90) in the complete image having intensity lower than the predetermined intensity threshold to identify the fish (90) in the complete image; and
classifying all pixels in the complete image by comparison with spectral signatures of fish (90) or specimen (80) stored in a database (60-65) to identify and classify physiological properties of the identified fish (90) or identify and classify specimen (80) on the complete image of the identified fish (90).

23. The method according to claim 22, further comprising a step of spectrally correcting an image of the identified fish (90) by using measurements of optical properties of water to model statistical distribution of the optical properties of the water to each pixel in the complete image of the fish (90) and subtracting this contribution from the optical properties in the complete image of the identified fish (90) to provide a corrected spectral image of the identified fish (90).

24. The method according to claim 23, wherein performing measurements of optical properties of the water is via using a separate illumination source (51) illuminating a desired light and a detector (52) arranged at a known distance (D) from the separate illumination source (51) to determine attenuation coefficient of water which can be used as spectral correction parameter for subtraction.

25. The method according to claim 22, further comprising accumulating spectral images of fishes (90) at various distances, and by using a determined attenuation coefficient to project the determined attenuation coefficient spectrum on all spectra and estimate the statistical contribution of the attenuation coefficient spectra to all spectra on all fishes (90) in the complete image of identified fish (90).

26. The method according to claim 25, further comprising confirming whether the contribution is continuous, and if the contribution is continuous subtracting the contribution of the attenuation coefficient spectra on every single pixel of the complete image of the identified fish (90) to yield a standardized spectral image.

27. The method according to claim 22, further comprising extracting each specimen (80) as an object.

28. The method according to claim 27, further comprising determining development of development stage of the detected specimen object.

29. The method according to claim 28, comprising grouping connected pixels of a common identified class, calculating texture properties including size and shape, extracting each specimen as an object, and comparing the texture properties of the specimen object with spectral signatures of specimen of different development stage from a database (61).

30. The method according to claim 29, comprising estimating the probability if the specimen being of various types.

31. The method according to claim 22, comprising identifying and classifying wounds, changes in skin color, changes in gill color, spots, darker color, loss of scales, changes in the eye or growth of wart-like excrescence by comparing the spectral image or standardized spectral image of the fish (90) with spectral signatures for wounds, skin color, gill color, scales, eye, wart-like excrescences from a database (62).

32. The method according to claim 22, comprising identifying and classifying life stage of the detected fish (90) by comparing the spectral image or standardized image of the fish (90) with spectral signatures of fish (90) at different life stages from a database (63).

33. The method according to claim 22, comprising identifying and classifying between different stages of parr-smolt transition of fish (90) by comparing the spectral image or standardized image of the fish (90) with spectral signatures of different stages of parr-smolt transition from a database (64).

34. A system for underwater hyperspectral imaging of fish (90) comprising at least one illumination source (10) and at least one hyperspectral imager (20) for hyperspectral imaging of a fish (90) freely moving in an observation area (100) providing a raw 2D projection of the convolution of the at least one illumination source (10) and at least one hyperspectral imager (20) and spectral properties of a section (101) of a fish (90) moving in the observation area (100), comprising a control unit (40) provided with software or another unit for:
utilizing movement of the fish (90) in relation to the observation area (100) to build a two dimensional image of the fish (90) from sequential sections (101) of the fish (90) captured by the at least one hyperspectral imager (20) as the fish (90) moves in relation to the observation area (100) and processing and composing the sequential sections (101) to generate a complete image of the fish (90),
identifying the fish (90) in the complete image by evaluating connected pixels in the complete image having a certain intensity threshold, and extracting area around the fish (90) in the complete image having intensity lower than the intensity threshold, and
identifying and classifying physiological properties of the identified fish (90) or identifying and classifying specimen (80) on the complete image of the identified fish (90) by classifying all pixels in the complete image by comparison with spectral signatures of fish (90) or specimen (80) stored in a database (60-65).

35. The system according to claim 34, further comprising a device (50) for measuring optical properties of water formed by at least one separate illumination source (51) and at least one detector (52), arranged at a known distance (D) from each other.

36. The system according to claim 34, wherein the control unit (40) includes with software or another unit for using the measured optical properties of the water to model the statistical distribution of the optical properties of the water to each pixel in the complete image of the identified fish (90), providing an attenuation coefficient spectrum, and subtracting the attenuation coefficient spectrum from the optical properties in the complete image of the identified fish (90) to provide a spectral image of the identified fish (90).

37. The system according to claim 34, wherein the control unit (40) further includes software or another unit for accumulating spectral images of fishes (90) at various distances by utilizing the attenuation coefficient spectrum by projecting the attenuation coefficient spectrum on all spectra and estimating statistical contribution of the attenuation coefficient spectra on all fishes in the complete image, confirming whether the contribution is continuous, and if the contribution is continuous, subtracting the contribution of the attenuation coefficient spectrum on every pixel to provide a standardized spectral image of fishes (90) in the complete image.

38. The system according to claim 34, wherein the control unit (40) is further includes software or another unit for grouping pixels of same class and calculating texture properties thereof including size and shape, and extracting each specimen (80) as an object.

39. The system according to claim 38, comprising at least one database (61) that stores spectral signatures of specimens (80) at different development stages, wherein the control unit (40) includes software or another unit for comparing the texture properties of the specimen (80) with the spectral signatures of the specimen (80) at different development stage in the database (61) to determine development stage of specimen (80) object.

40. The system according to claim 34, comprising at least one database (62) that stores spectral signatures for wounds, changes in skin color, changes in gill color, spots, darker color, loss of scales, changes in the eye or growth of wart-like excrescence, wherein the control unit (40) includes software or another unit for comparing the spectral image or standardized spectral image of the fish (90) with spectral signatures for wounds, skin color, gill color, scales, eye, wart-like excrescences in the database (62) for determining wounds, changes in skin color, changes in gill color, spots, darker color, loss of scales, changes in the eye or growth of wart-like excrescence.

41. The system according to claim 34, comprising at least one database (63) that stores spectral signatures of fish (90) at different life stages, wherein the control unit (40) includes software or another unit for comparing the spectral image or standardized spectral image of the fish (90) with spectral signatures for the different life stages in the database (63) for determining life stage of fish (90).

42. The system according to claim 34, comprising at least one database (64) that stores spectral signatures for different stages of parr-smolt transition of fish (90), wherein the control unit (40) includes software or another unit for comparing the spectral image or standardized spectral image of the fish (90) with spectral signatures the different stages of parr-smolt transition in the database (64) for determining stages of parr-smolt transition of fish (90).
